(19) United States
(12) Patent Application Publication
(10) Pub. No.: US 2025/0217898 A1
(43) Pub. Date: Jul. 3, 2025

(54) INTEGRATED SOCIAL NETWORKING SYSTEM AND METHOD TO OPERATE THE SAME

(71) Applicant: RAVNEET SINGH, CORAL SPRINGS, FL (US)

(72) Inventor: RAVNEET SINGH, CORAL SPRINGS, FL (US)

(21) Appl. No.: 18/399,892

(22) Filed: Dec. 29, 2023

(51) Int. Cl. G06Q 50/00; G06Q 20/02; G06Q 30/018; G06Q 30/0207; G06Q 30/0226; H04L 9/40

(52) U.S. Cl. CPC G06Q 50/01; G06Q 20/027; G06Q 30/018; G06Q 30/0231; G06Q 30/0239; H04L 63/102

(57) ABSTRACT

A social networking system is provided. The system encompasses a robust processing subsystem hosted on a server, comprises various modules including a registration module linking social media accounts, a blockchain-backed bio page module storing audience metrics, a payment gateway with a reward system, and a CRM module offering dashboards for influencers, brands, agencies, and followers. An analysis module integrates natural language processing to assess content tone, engagement, and sentiment. A button module generates emoticon categorization and auto-suggestions based on metadata, leveraging machine learning for predictions. A compliance analysis module ensures adherence to regulations in paid social media content, and a royalty distribution module calculates and allocates royalties based on engagement, location, compliance, and fan type via smart contracts. This comprehensive subsystem integrates functionalities to elevate user interaction, content analysis, and monetization opportunities within the social media platforms.

### FIELD OF INVENTION

Embodiments of the present disclosure relate to a platform that integrates multiple tasks and services associated with identifying, tracking, validating, and connecting with certain users of social networks, and more particularly to, an integrated social networking system and a method to operate the same.

### BACKGROUND

A social networking platform is an online service or website that allows individuals to create and maintain personal profiles, connect with other users, and share various forms of content such as text, photos, videos, and links. These platforms provide a virtual space for users to establish and strengthen social connections, both with people they already know and with new contacts who share similar interests or backgrounds. Common features of social networking platforms include friend or follower systems, news feeds displaying updates from connections, messaging capabilities, and tools for content sharing and interaction. Existing platforms provide advanced features to create a unified space where users, influencers, and brands can engage, analyze content, and explore innovative avenues for monetization.

Many existing social networking platforms face challenges in providing a comprehensive and streamlined user experience. Existing platforms may lack the sophisticated user engagement features such as a reward system and diverse engagement buttons, potentially leading to lower user interaction and satisfaction. They do not employ advanced AI models to analyze social media content comprehensively, resulting in limited insights into tone, sentiment, and engagement. Unlike the detailed CRM module, existing systems may not offer such granular control over user data, potentially raising privacy concerns and limiting user trust.

Existing platforms may lack the intricate monetization features presented, such as the royalty distribution module and limiting influencers' and users' opportunities for financial gain. The absence of a dedicated influencer admin module in existing platforms may hinder the effective management of fan relationships, including categorization and third-party access. Existing systems may not have a dedicated compliance analysis, leading to potential issues with paid posts and adherence to regulations, which could impact both users and the platform itself. While some existing platforms may have marketplaces, however, they might lack the seamless integration of digital products and services with a payment gateway.

Moreover, the absence of a feature-rich private group in existing platforms may result in a lack of credibility and reputation building opportunities for influencers and restricted engagement for followers. Existing platforms may not provide in-depth analytics for content performance, potentially hindering influencers and users from making data-driven decisions to enhance their online presence.

Hence, there is a need for an improved social networking system to address the aforementioned issues.

### BRIEF DESCRIPTION

In accordance with an embodiment of the present disclosure, integrated social networking system is disclosed. The system includes a hardware processor. The system also includes a memory coupled to the hardware processor, wherein the memory comprises a set of program instructions in the form of a processing subsystem, configured to be executed by the hardware processor, wherein the processing subsystem is hosted on a server and configured to execute on a network to control bidirectional communications among a plurality of modules. The processing subsystem includes a registration module configured to perform user registration using one or more credentials to link a plurality of social media accounts. The processing subsystem also includes a bio page module employing blockchain technology for data storage, wherein the bio page module configured to store total audience reach and engagement metrics obtained from a plurality of linked social media accounts. The processing subsystem further includes a payment gateway module is configured to facilitate seamless transactions and incorporating a reward system based on the total audience reach and engagement metrics. The processing subsystem further includes a customer relationship management (CRM) module configured to provide a plurality of dashboards for influencers, brands, agencies, and followers, with an administrative module for influencer-fan relationship management, third-party account access, and follower categorization. The processing subsystem further includes an analysis module integrating natural language processing and configured to analyse social media content considering tone, engagement, and sentiment, wherein the natural language processing identifies linguistic cues to determine positive, negative, or neutral tone in the social media content based on a plurality of factors comprising word choice, sentence structure, and context, wherein the natural language processing evaluates a way of user interaction with the social media content by tracking likes, shares, comments, and other metrics to analyse engagement, wherein the natural language processing analyses overall emotional tone of a piece of content by identifying joy, anger, sadness, or other emotions in the social media content to analyse sentiments. The processing subsystem further includes a button module comprising like, mention, and hashtag buttons, configured to generate emoticon categorization and auto-suggestions based on metadata. The button module is also configured to predict and suggest relevant emoticons, mentions, and hashtags based on past user behavior, post content, and engagement patterns using machine learning algorithms. The processing subsystem further includes a compliance analysis module configured to determine and ensure compliance with laws applicable to varying jurisdictions and equivalent regulations of a corresponding governing body for compliance using one or more inputs upon identifying the transaction related data to adhere to regulations in paid social media content. The processing subsystem further includes a royalty distribution module is configured to calculate a plurality of royalties based on a predetermined percentage embedded in a smart contract on the blockchain platform for engagement, location, compliance, and fan type. The royalty distribution module is also configured to distribute the plurality of royalties based on the engagement, the location, the compliance, and the fan type using a distribution algorithm, thereby integrating functionalities to enhance user interaction, content analysis, and monetization opportunities.

In accordance with another embodiment of the present disclosure, a method for operating social networking system is disclosed. The method includes performing, by a registration module, user registration using one or more credentials to link a plurality of social media accounts. The method also includes storing, by a bio page module, total audience reach, and engagement metrics obtained from a plurality of linked social media accounts, wherein the bio page is employed with blockchain technology for data storage. The method further includes facilitating, by a payment gateway module, seamless transactions and incorporating a reward system based on the total audience reach and engagement metrics. The method further includes providing, by a customer relationship management (CRM) module, a plurality of dashboards for influencers, brands, agencies, and followers, with an administrative module for influencer-fan relationship management, third-party account access, and follower categorization. The method further includes analysing, by a analysis module, social media content considering tone, engagement, and sentiment, wherein the natural language processing identifies linguistic cues to determine positive, negative, or neutral tone in the social media content based on a plurality of factors comprising word choice, sentence structure, and context, wherein the natural language processing evaluates a way of user interaction with the social media content by tracking likes, shares, comments, and other metrics to analyse engagement, wherein the natural language processing analyses overall emotional tone of a piece of content by identifying joy, anger, sadness, or other emotions in the social media content to analyse sentiments. The method further includes generating, by a button module, emoticon categorization and auto-suggestions based on metadata. The method further includes predicting and suggesting, by the button module, relevant emoticons, mentions, and hashtags based on past user behavior, post content, and engagement patterns using machine learning algorithms. The method further includes determining and ensuring, by a compliance module, compliance with laws applicable to varying jurisdictions and equivalent regulations of a corresponding governing body for compliance using one or more inputs upon identifying the transaction related data to adhere to regulations in paid social media content. The method further includes calculating, by a royalty distribution module, a plurality of royalties based on a predetermined percentage embedded in a smart contract on the blockchain platform for engagement, location, compliance, and fan type. The method further includes distributing, by the royalty distribution module, the plurality of royalties based on the engagement, the location, the compliance, and the fan type using a distribution algorithm, thereby integrating functionalities to enhance user interaction, content analysis, and monetization opportunities.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of an integrated social networking system in accordance with an embodiment of the present disclosure;

FIG. 2 is a block diagram of an embodiment of an integrated social networking system in accordance with an embodiment of the present disclosure;

FIG. 3 is a schematic representation of an exemplary embodiment of an integrated social networking system of FIG. 1 in accordance with an embodiment of the present disclosure;

FIG. 4 is a block diagram of a computer or a server in accordance with an embodiment of the present disclosure;

FIG. 5(a) is a flow chart representing the steps involved in a method for operating an integrated social networking system of FIG. 1 in accordance with an embodiment of the present disclosure; and

FIG. 5(b) is a flow chart representing the continued steps of method of FIG. 5(a) in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to integrated social networking system. As used herein, “social networking system is a platform to integrate all online social media platforms which people use to build social networks or social relationships with other people who share similar personal or career content, interests, activities, backgrounds or real-life connections.”. The main solutions disclosed herein relate to a new approach within social media applications or entities. As used herein, the term “application” (or “app”) refers generally and without limitation to a unit of executable software that implements a certain functionality or theme, including as found in a social media environment. The themes of applications vary broadly across any number of disciplines and functions (such as on-demand content management, e-commerce transactions, posts, blockchain transactions, etc.), and an application may have more than one theme. The unit of executable software generally runs in a predetermined environment. For example, a processor apparatus may obtain and execute instructions from a non-transitory computer-readable storage medium where the instructions are compiled for the processor on a network receiving and sending data from a social media platform. The system provides a streamlined and consistent approach to the blockchain environment surrounding social media platforms. As used herein “the blockchain environment includes a blockchain platform which is a shared digital ledger that allows users to record transactions and share information securely, tamper resistant. The social network analysis is the study of social networks where ties are the various types of connections between nodes and node are the individual actors within the networks, and ties are the relationships between the actors.

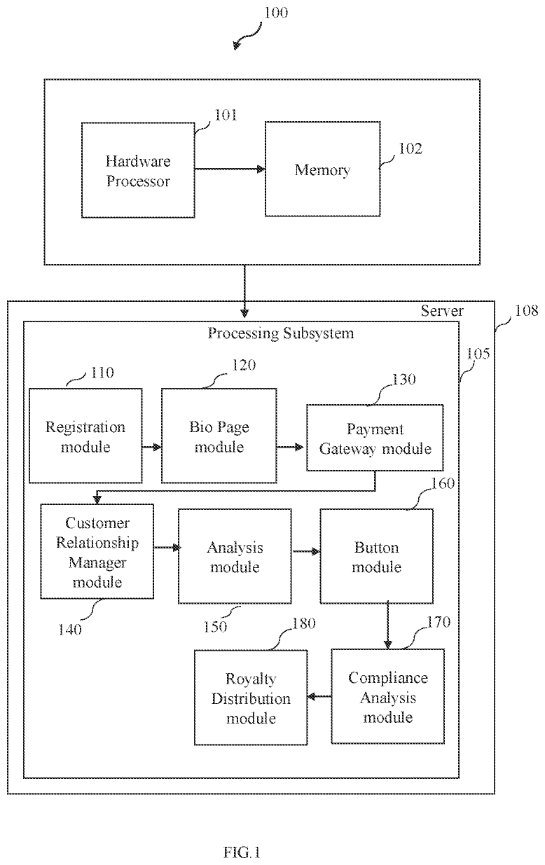

FIG. 1 is a block diagram of an integrated social networking system 100 in accordance with an embodiment of the present disclosure. The system 100 includes a hardware processor 101 and a memory 102 coupled to the hardware processor 101. The memory 102 includes a set of program instructions in the form of a processing subsystem 105 and configured to be executed by the hardware processor 101. As used herein, the hardware processor performs data processing, decision making, and all general computing tasks and coordinates tasks done by memory, disk storage, and other system components. The processing subsystem 105 is hosted on a sever 108. In one embodiment, the server 108 may include a cloud server. In another embodiment, the server 108 may include a local server. The processing subsystem 105 is configured to execute on a network (not shown in FIG. 1) to control bidirectional communications among a plurality of modules. In one embodiment, the network may include a wired network such as local area network (LAN). In another embodiment, the network may include a wireless network such as Wi-Fi, Bluetooth, Zigbee, near field communication (NFC), infra-red communication (RFID) or the like. The processing subsystem 105 includes a registration module 110 configured to perform user registration using one or more credentials to link a plurality of social media accounts. In one embodiment, the one or more credentials may include email and phone number. In some embodiments, the registration module 110 is configured to receive current location from the user to set a user profile. The current location may be provided through global positioning system (GPS). In a specific embodiment, the user may include a follower, an influencer or a brand.

Also, the processing subsystem 105 includes a bio page module 120 employing blockchain technology for data storage. The bio page module 120 configured to store total audience reach and engagement metrics obtained from a plurality of linked social media accounts. In one embodiment, the bio page module 120 is configured to display total audience reach, total number of likes, total number of mentions and total number of hashtags from a plurality of social media accounts. In detail, the bio page serves as a personalized space for users to showcase and share key information about themselves. The functionality and features of a bio page can vary across platforms. The users may provide basic profile information such as their name, username, profile picture, and a brief bio or description. This information is often visible to other users when they visit the profile. The bio page may allow users to include contact details such as email addresses or links to external websites. This enables users to connect with the individual outside the platform. The users may have the option to link and display their accounts from other social media platforms, creating a connected online presence. The bio page module 120 may incorporate blockchain technology to store data related to total audience reach. This can include metrics such as the total number of followers, likes, and mentions aggregated from various social network platforms. The bio page may display engagement metrics, showcasing the user's popularity and influence. This may include data such as the total number of likes, mentions, and hashtags associated with the user's content across different social networks. The use of blockchain technology in the bio page ensures secure and tamper-proof storage of data. This technology provides transparency and integrity to the user's metrics, enhancing trust among followers and potential collaborators. The users may have the ability to customize the appearance of their bio page, such as choosing a background color or theme, allowing for a more personalized and visually appealing profile. Overall, the bio page on a social media-based platform acts as a centralized hub for users to present a snapshot of their online identity, engagement metrics, and total audience reach, contributing to a comprehensive and visually appealing user experience.

Furthermore, the processing subsystem 105 also includes a payment gateway module 130 configured to facilitate seamless transactions and incorporate a reward system based on the total audience reach and engagement metrics. In one embodiment, the payment gateway module 130 is configured to enable the user to shop, add to cart, pay and checkout, generate invoice and receipt of digital products or services in the marketplace interface. In some embodiments, the payment gateway module 130 is configured to allow the users to mention people or add hashtag in the social media content, wherein the people mentioned, or hash tagged in the social media content are rewarded points automatically by the social media platform. In such an embodiment, the payment gateway module 130 is configured to allow the users to reward other users for engagement. In one embodiment, payola refers to the practice of influencers or content creators receiving payment or other incentives to promote a product, service, or brand without adequately disclosing this arrangement to their audience. In the spirit of transparency, many social media platforms and regulatory bodies have guidelines in place to ensure that audiences are aware of any financial relationships. For example, the Federal Trade Commission (FTC) in the U.S. requires influencers to clearly disclose their relationships with brands. This can be done through hashtags like #ad, #sponsored, or similar clear and conspicuous language. For influencers and content creators, it's not just a legal obligation; it's about maintaining trust with their audience. Most social media platforms also have their own guidelines regarding disclosure. From Instagram to YouTube, each has its own rules on how influencers should disclose partnerships or sponsored content. Furthermore, failure to disclose paid partnerships can lead to legal consequences and damage to the influencer's credibility. It's a delicate balance, influencers need to strike a chord between monetizing their content and maintaining the trust of their audience.

The processing subsystem 105 further includes a customer relationship management (CRM) module 140 configured to provide a plurality of dashboards for influencers, brands, agencies, and followers, with an administrative module for influencer-fan relationship management, third-party account access, and follower categorization. In one embodiment, the customer relationship management module 140 is configured to enable an influencer to create a database comprising details of fans such as type of a fan, how to connect and relationship of influencer with the fan. In some embodiment, the customer relationship management module 140 is configured to group all the followers into different categories comprising sports, movies, membership, engagement and geography suggested by the social media platform. In such an embodiment, the customer relationship management module 140 is configured to manage sales performance management (SPM) for users (clients/influencers) along with other users (followers and brands along with their followers). In one embodiment, the customer relationship management module 140 is configured to allow influencer to create database which comprises details of fans such as type of fan, how to connect and relationship of influencer with fan. In a specific embodiment, the CRM module 140 is configured to group all the followers into different categories such as sports, movies, membership, engagement, geography or the like suggested by the platform. In a particular embodiment, the CRM module 140 may include web application dashboard admin, brands dashboard admin, agencies/enterprise dashboard admin, follower dashboard admin. In some embodiments, the CRM module 140 is configured to allow followers to follow a group or a specific person of the group. In such an embodiment, CRM module 140 is configured to allow the user to become strong fan by following a group along with member of group to showcase fandom interest. In one embodiment, the CRM module 140 is configured to find and organize accounts followed by followers. In some embodiment, the CRM module 140 is configured to group all the followed group by the follower into different categories such as sports, movies, membership, engagement, geography suggested by the platform.

In one embodiment, if an influencer is being paid to promote a product or service, they are required to disclose this material connection to their audience. It includes transparency in advertising and ensuring that viewers are aware of any financial incentives behind the promotion. In some cases, when influencers receive products for free in exchange for promotion. This is a common form of compensation in influencer marketing. In some cases, endorsement includes actively supporting or promoting a product, service, or brand. Endorsements can be paid or unpaid, and disclosure is crucial for transparency. Furthermore, various forms of promotions where participants can win prizes, get involved in contests having skill, sweepstakes are based on chance, and lotteries typically involve a purchase. Rules, disclosures, and legal considerations are important in these activities.

Moreover, the processing subsystem 105 includes an analysis module 150 integrating natural language processing and configured to analyse social media content considering tone, engagement, and sentiment. The natural language processing identifies linguistic cues to determine positive, negative, or neutral tone in the social media content based on a plurality of factors comprising word choice, sentence structure, and context. The natural language processing evaluates a way of user interaction with the social media content by tracking likes, shares, comments, and other metrics to analyse engagement. The natural language processing analyses overall emotional tone of a piece of content by identifying joy, anger, sadness, or other emotions in the social media content to analyse sentiments. In one embodiment, the analysis module 150 is configured to use one or more machine learning models comprising Support Vector Machines (SVM), Random Forests, Regression Models, Neural Networks, Random Forest Regressor and Convolutional Neural Networks (CNNs).

In detail, support vector machines are effective for binary classification tasks, such as determining positive or negative tones in text. Random Forests are an ensemble learning method that combines multiple decision trees, making them versatile for tone analysis. Naive Bayes classifiers, particularly the multinomial variant, are often used for text classification tasks, including tone analysis. Linear regression or logistic regression can be employed to predict engagement metrics (likes, shares, comments) based on various features. Deep learning models, such as feedforward neural networks, can capture complex relationships between input features and engagement metrics. Similar to classification, random forests can be adapted for regression tasks, making them suitable for predicting engagement levels. RNNs, especially with Long Short-Term Memory (LSTM) cells, are effective for sequence modelling in sentiment analysis tasks. CNNs can be applied to capture local patterns and relationships in text, making them suitable for sentiment classification.

In one embodiment, the analysis module 150 is configured to filter each social media content by tone based on identifying joy, anger, confidence and fear from the social media content. In such an embodiment, the analysis module 150 is configured to filter each social media content by engagement based on engagement rate in the social media content comprising like, share and comment. In one embodiment, the analysis module 150 is configured to provide weightage to like, share, comment, follow based on time taken for the engagement, wherein the weightage to the comments is based on number of words and tonality and intensity of tonality on the comments. In a specific embodiment, the analysis module 150 is configured to aggregate all engagements such as like, comments to identify popularity of post.

In addition, the processing subsystem 105 further includes a button module 160 comprising like, mention, and hashtag buttons. The button module 160 is configured generate emoticon categorization and auto-suggestions based on metadata. The button module 160 is configured to predict and suggest relevant emoticons, mentions, and hashtags based on past user behavior, post content, and engagement patterns using machine learning models. In one embodiment, the like button of the button module 160 is configured to provide a plurality of emoticon under like button to further categorize the likeness on the social media content as positive, negative or neutral response to define intensity of like, wherein the intensity of like is based on how long a specific button is pressed. In another embodiment, the mention button of the button module 160 is configured to automatically suggest mentions based on meta data comprising surrounding, location, image analysis of the social media content, wherein the mentions are pre-populated based on the meta data using the one or more machine learning models, wherein the mentions are removed from the social media content when the user disapprove the social media content. In yet another embodiment, the hashtag button of the button module 160 is configured to automatically suggest hashtags based on meta data comprising surrounding, location, image analysis of the social media content, wherein the hashtags are pre-populated based on the meta data using the one or more machine learning models.

Subsequently, the processing subsystem 105 includes a compliance analysis module 170 configured to determine and ensure compliance with laws applicable to varying jurisdictions and equivalent regulations of a corresponding governing body for compliance using one or more inputs upon identifying the transaction related data to adhere to regulations in paid social media content. In one embodiment, the compliance module 170 is configured to automatically suggest creation of the social media based on compliance by selecting (adding hashtag, image, code, URL, reference or disclosure) or correcting the post based on compliance or deny the post (or part of post) based on the compliance. Specifically, in one embodiment, transaction-related data are data relating to NFTs, cryptocurrency, and the like that can be identified together with other information that is in or is likely to come into the possession of the entity on a given social media platform. In some embodiments, social media compliance may ensure marketing content across social media channels follows the rules and regulations set by the relevant government or authority. In such embodiment, compliance may include industry-specific regulations, such as those for financial services, as well as regulations specific to consumer protection. Businesses and marketers using social media must follow regulations and abide by compliance obligations to avoid penalties and other potential fallout.

In one embodiment, the algorithm and database of compliance regulations may populate the proper output response depending on the network, blockchain, social media platform, or another environment. In one scenario, before a post is published, the algorithm uses the database to cross reference regulations from the location of the post to insert the appropriate hashtag in the description and/or include additional data on the blockchain to comply with the regulations. For example, popular social media platform such as Instagram® inform influencers to use the branded content tag to identify the relationship. However, if the influencer doesn't use the tag, there is nothing Instagram can do to help the influencer. This method and system for compliance rectifies this issue by automatically including the necessary description and data for compliance. If a brand contacted an influencer through the system to sponsor a post, the post will automatically have the #ad or country equivalent in the description so the brand and influencer do not have to risk it. Both brands and influencers want an easy way to ensure compliance because of the fines for violating these rules. This solves the problem technologically by identifying the location of the user and displaying the #ad or country equivalent, making the post compliant. In one embodiment, the compliance analysis module is also configured to protect false advertisement disclosure, truthfulness about the product and government or regulatory protection for viewer awareness. More specifically, false advertising disclosure is the commitment to be transparent about the products or services being promoted. It involves clearly communicating any affiliations, partnerships, or sponsorships, and ensuring that the information shared about the product is accurate. Influencers and content creators are expected to make it known when they are being compensated for promoting a product, using hashtags like #ad or #sponsored. This disclosure is not just a legal requirement; it's about maintaining trust with the audience. Similarly, truthfulness in social media content revolves around presenting an accurate and honest portrayal of the product or service. This includes providing genuine reviews, showcasing actual use, and being transparent about any limitations or drawbacks. Misleading claims or exaggerated benefits can not only harm the brand's reputation but also lead to legal consequences. Social media platforms often have guidelines against deceptive practices, emphasizing the importance of honesty in content creation. Moreover, governments and regulatory bodies play a crucial role in ensuring that viewers are protected from deceptive practices on social media. Various countries have established guidelines and laws to govern advertising and disclosure on digital platforms. For example, the Federal Trade Commission (FTC) in the United States has specific regulations that require influencers to disclose their relationships with brands. These regulations aim to safeguard the audience, empowering them to make informed decisions by knowing the context of the content they consume.

In one embodiment, the compliance analysis module is also configured to communicate and maintain with a plurality of regulatory bodies such as FTC, SEC and FEC. In essence, these regulatory bodies play a crucial role in maintaining a fair, transparent, and lawful environment on social media. Whether it's about consumer protection, securities laws, or political transparency, the FTC, SEC, and FEC contribute to shaping a responsible and accountable landscape for influencers, brands, and individuals alike. The Federal Trade Commission (FTC) is a key player in ensuring transparency and consumer protection in the realm of social media. Their focus is on truth in advertising and disclosure. Influencers and content creators fall under their scrutiny to make sure they are transparent about their relationships with brands. The FTC guidelines require clear and conspicuous disclosure of any financial or material connections between an influencer and a brand. Hashtags like #ad, #sponsored, or similar phrases are often used to comply with these regulations. The Securities and Exchange Commission (SEC) is primarily associated with regulating the securities industry, its influence extends to social media in cases where influencers or companies discuss publicly traded stocks or securities. If an influencer provides financial advice, discusses stock performance, or engages in any activities that could impact securities, the SEC might step in to ensure compliance with securities laws. The goal is to prevent fraud and ensure a fair and transparent financial market. The Federal Election Commission (FEC) comes into play in the context of political campaigns and advertisements on social media. If influencers or individuals are involved in promoting or endorsing political content, candidates, or campaigns, they may be subject to FEC regulations. This includes disclosure requirements for political contributions and disclaimers on political ads. The FEC aims to maintain transparency in political messaging to empower voters with accurate information.

Additionally, the processing subsystem 105 further includes a royalty distribution module 180 is configured to calculate a plurality of royalties based on a predetermined percentage embedded in a smart contract on the blockchain platform for engagement, location, compliance, and fan type. The royalty distribution module 180 is also configured to distribute the plurality of royalties based on the engagement, the location, the compliance, and the fan type using a distribution algorithm, thereby integrating functionalities to enhance user interaction, content analysis, and monetization opportunities. In one embodiment, royalty distribution module 180 is configured to provide royalty changing suggestion on post for the mention, hashtag, as good, bad or fair deal based on plurality of factors (such as number of followers, other influencer account data). In such an embodiment, the royalty distribution module 180 distributes the royalty of the post based on the combination and permutation of engagement of the user (hashtag, mention, like, comment) location, compliance, type of fan of the post. In a specific embodiment, the royalty distribution module 180 is configured to provide royalty suggestion based on geography, culture, custom, compliance and currency. In one embodiment, the royalty percentage may be set on total sale or fixed amount, the recipients are set, the percentage of the royalty share for each recipient is allocated, a secondary NFT sale price and earn ongoing royalties may be used, then the assignment of royalties to user wallets may occur, including possible royalties assigned to charity accounts, which may also include a selection of destination of royalty payments. After the algorithm is ran and once the calculation is generated, they will be assigned in the database and blockchain as well as in the smart contract. The amount is then allocated at time of the sale in crypto or by third party sites that allow NFT transactions.

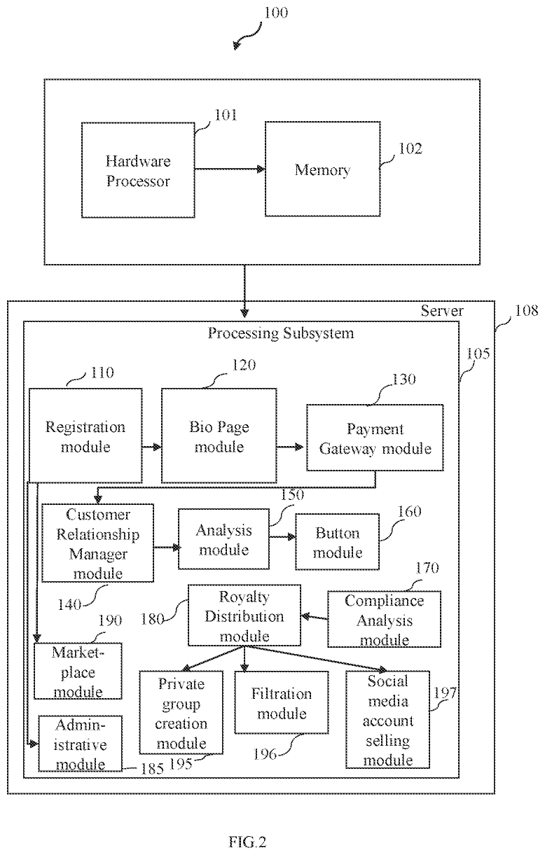

FIG. 2 is a block diagram representation of an embodiment of the system of FIG. 1 in accordance with an embodiment of the present disclosure. The system of FIG. 1 includes a processing subsystem 105 including a registration module 110, a bio page module 120, a payment gateway module 130, a customer relationship management module 140, an analysis module 150, a button module 160, a compliance analysis module 170 and a royalty distribution module 180. In one embodiment, the processing subsystem 105 may include an administrative module 185 configured to provide customer of one user to another user. In another embodiment, the processing subsystem 105 may include a marketplace module 190 configured to offer or sell digital products or services in a marketplace interface for a user. In such an embodiment, the marketplace module 190 is configured to charge the user for commenting.

In one embodiment, the processing subsystem 105 may include a private group creation module 195 configured to enable the user to establish and manage a private group for followers with membership. The private group creation module 195 is also configured to permit the user to post content within the private group, wherein the content is exclusively accessible to followers with membership in the private group. The private group creation module 195 is further configured to enable followers to review, or rate posted content within the private group using a review button, wherein the review button, when activated by a follower, facilitates the generation of credibility, reputation, and popularity metrics associated with the posted content based on the follower's review or rating.

In a specific embodiment, the processing subsystem 105 may include a filtration module 196 configured to filter paid and unpaid posts, wherein the paid posts of a specific user is aggregated and provided on a single feed. In such an embodiment, the filtration module 196 is configured to rank a common post on different social media platforms based on most engaged post of the specific user on any specific social media platform. In a particular embodiment, the processing subsystem 105 may include a social media account selling module 197 configured to offer social media account of other users for sale to the user.

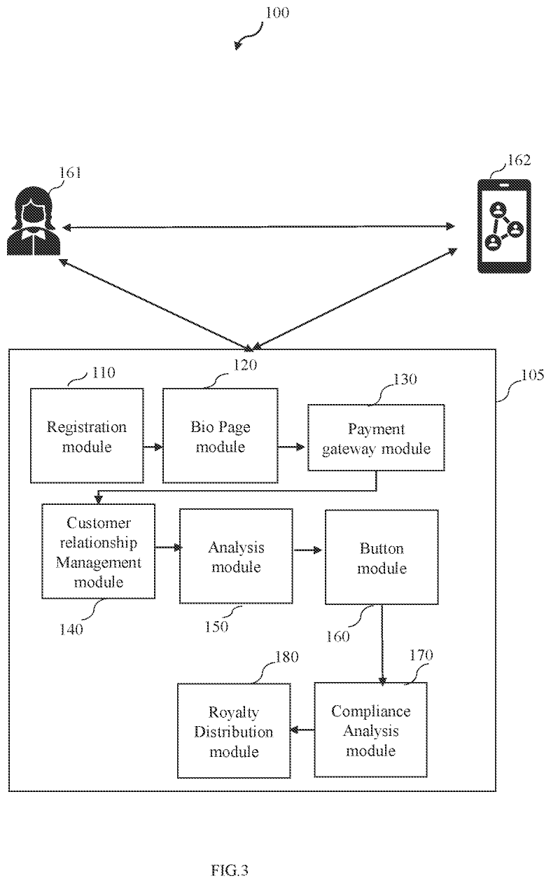

FIG. 3 is a schematic representation of an exemplary embodiment of system 100 of FIG. 1 in accordance with an embodiment of the present disclose. Considering a real time scenario where a user Sarah 161, a popular lifestyle influencer, joining the social networking system 100 that incorporates advanced features for content monetization and analytics. Sarah seamlessly registers on the system using her credentials, effortlessly linking her diverse social media accounts 162 to create a unified and easily accessible profile using the registration module 110. The bio page module 120 captures and securely stores Sarah's total audience reach and engagement metrics from her linked social media accounts, offering her a comprehensive view of her impact across platforms. As Sarah posts engaging content, the payment gateway module 130 ensures smooth and secure transactions. The reward system kicks in, acknowledging her growing audience reach and high engagement metrics with incentives and bonuses. Sarah accesses personalized dashboards through the CRM module 140. It empowers her with insights into her follower demographics, preferences, and engagement patterns. The administrative module 185 assists in managing her relationships with fans and provides secure third-party account access. The analysis module 150 employs natural language processing to dissect Sarah's content. It identifies positive, negative, or neutral tones, gauges user interaction by tracking likes, shares, and comments, and even delves into the emotional nuances of her posts, enhancing her understanding of audience sentiment.

Furthermore, the button module 160 adds flair to Sarah's posts, suggesting emoticons, mentions, and hashtags based on her past user behavior, content history, and engagement patterns. This not only saves time but also boosts the visibility of her content. Sarah, a global influencer, benefits from the compliance analysis module 170, ensuring her content adheres to varying laws and regulations. The system dynamically adjusts to the jurisdiction, keeping her in compliance and fostering a trustworthy online presence. The royalty distribution module 180 calculates royalties for Sarah based on her engagement, audience location, compliance with regulations, and fan type. The smart contracts embedded in the blockchain ensure fair and transparent royalty distribution, optimizing her monetization opportunities. In this real-life scenario, the integrated functionalities of the platform enhance Sarah's user experience, providing her with comprehensive analytics, streamlined monetization, and tools for compliance, ultimately elevating her influence and impact in the ever-evolving landscape of social media.

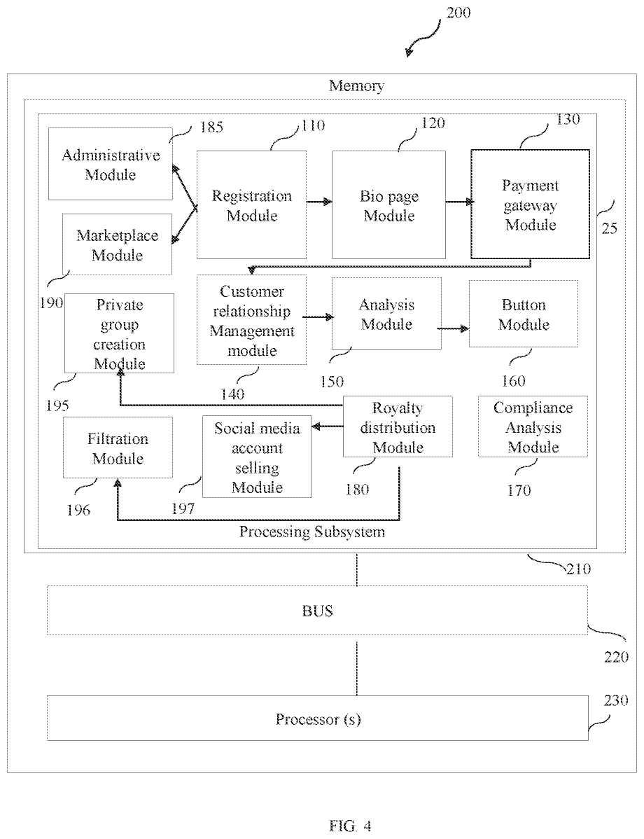

FIG. 4 is a block diagram of a computer or a server in accordance with an embodiment of the present disclosure. The server 200 includes processor(s) 230, and memory 210 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 includes a processing subsystem 105 of FIG. 1. The processing subsystem 105 further has following modules: a registration module 110, a bio page module 120, a payment gateway module 130, a customer relationship management module 140, an analysis module 150, a button module 160, a compliance analysis module 170 and a royalty distribution module 180, an administrative module 185, a marketplace module 190, a private group creation module 195, a filtration module 196 and a social media account selling module 197.

The processing subsystem 105 includes a registration module 110 configured to perform user registration using one or more credentials to link a plurality of social media accounts. The processing subsystem 105 also includes a bio page module 120 employing blockchain technology for data storage, wherein the bio page module 120 configured to store total audience reach and engagement metrics obtained from a plurality of linked social media accounts. The processing subsystem 105 further includes a payment gateway module 130 is configured to facilitate seamless transactions and incorporating a reward system based on the total audience reach and engagement metrics. The processing subsystem 105 further includes a customer relationship management (CRM) module 140 configured to provide a plurality of dashboards for influencers, brands, agencies, and followers, with an administrative module for influencer-fan relationship management, third-party account access, and follower categorization. The processing subsystem 105 further includes an analysis module 150 integrating natural language processing and configured to analyse social media content considering tone, engagement, and sentiment, wherein the natural language processing identifies linguistic cues to determine positive, negative, or neutral tone in the social media content based on a plurality of factors comprising word choice, sentence structure, and context, wherein the natural language processing evaluates a way of user interaction with the social media content by tracking likes, shares, comments, and other metrics to analyse engagement, wherein the natural language processing analyses overall emotional tone of a piece of content by identifying joy, anger, sadness, or other emotions in the social media content to analyse sentiments. The processing subsystem 105 further includes a button module 160 comprising like, mention, and hashtag buttons, configured to generate emoticon categorization and auto-suggestions based on metadata. The button module 160 is also configured to predict and suggest relevant emoticons, mentions, and hashtags based on past user behavior, post content, and engagement patterns using machine learning algorithms. The processing subsystem 105 further includes a compliance analysis module 170 configured to determine and ensure compliance with laws applicable to varying jurisdictions and equivalent regulations of a corresponding governing body for compliance using one or more inputs upon identifying the transaction related data to adhere to regulations in paid social media content. The processing subsystem 105 further includes a royalty distribution module 180 is configured to calculate a plurality of royalties based on a predetermined percentage embedded in a smart contract on the blockchain platform for engagement, location, compliance, and fan type. The royalty distribution module 180 is also configured to distribute the plurality of royalties based on the engagement, the location, the compliance, and the fan type using a distribution algorithm, thereby integrating functionalities to enhance user interaction, content analysis, and monetization opportunities.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus and the like.

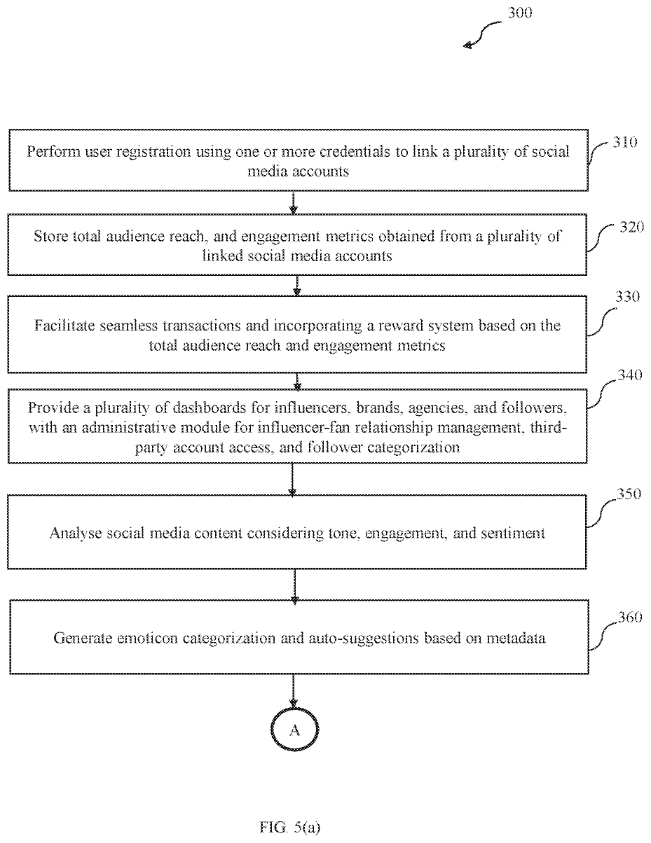

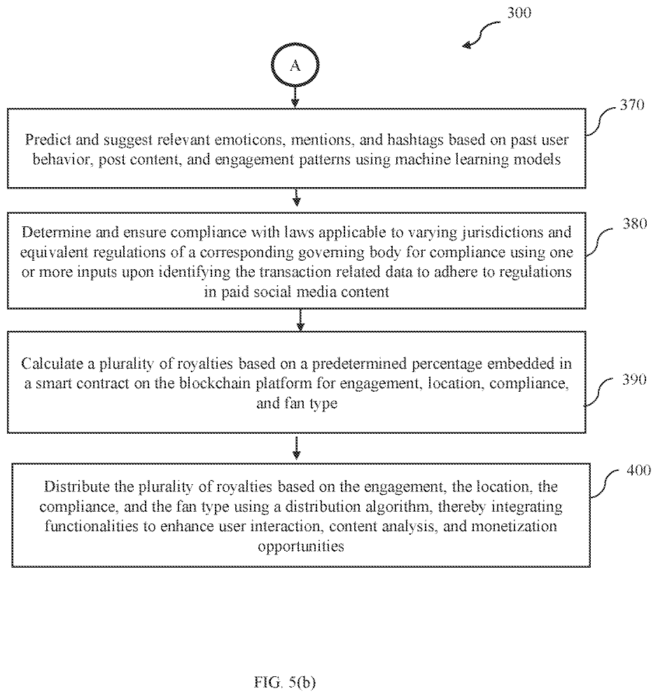

FIG. 5(a) is a flow chart representing the steps involved in a method 300 for operative an integrated social networking system FIG. 1 in accordance with an embodiment of the present disclosure. FIG. 5(b) is a flow chart representing the continued steps of method for operating the integrated social networking system of FIG. 5(a) in accordance with an embodiment of the present disclosure. The method 300 includes performing, by a registration module, user registration using one or more credentials to link a plurality of social media accounts in step 310. The method 300 also includes storing, by a bio page module, total audience reach, and engagement metrics obtained from a plurality of linked social media accounts, wherein the bio page is employed with blockchain technology for data storage in step 320. In one embodiment, displaying the total audience reach and engagement metrics may include displaying total audience reach, total number of likes, total number of mentions and total number of hashtags from a plurality of social media accounts.

The method 300 further includes facilitating, by a payment gateway module, seamless transactions and incorporating a reward system based on the total audience reach and engagement metrics in step 330. In one embodiment, facilitating the seamless transaction may include enabling the user to shop, add to cart, pay and checkout, generate invoice and receipt of digital products or services in the marketplace interface. In some embodiments, incorporating the reward system may include allow the users to mention people or add hashtag in the social media content, wherein the people mentioned, or hash tagged in the social media content are rewarded points automatically by the social media platform. The method 300 further includes providing, by a customer relationship management (CRM) module, a plurality of dashboards for influencers, brands, agencies, and followers, with an administrative module for influencer-fan relationship management, third-party account access, and follower categorization in step 340. In one embodiment, providing the plurality of dashboards may include enabling an influencer to create a database comprising details of fans such as type of a fan, how to connect and relationship of influencer with the fan. In some embodiments, providing the plurality of dashboards may include grouping all the followers into different categories comprising sports, movies, membership, engagement and geography suggested by the social media platform. In a specific embodiment, providing the plurality of dashboards may include managing sales performance management (SPM) for users (clients/influencers) along with other users (followers and brands along with their followers).

The method 300 further includes analysing, by a analysis module, social media content considering tone, engagement, and sentiment in step 350, wherein the natural language processing identifies linguistic cues to determine positive, negative, or neutral tone in the social media content based on a plurality of factors comprising word choice, sentence structure, and context, wherein the natural language processing evaluates a way of user interaction with the social media content by tracking likes, shares, comments, and other metrics to analyse engagement, wherein the natural language processing analyses overall emotional tone of a piece of content by identifying joy, anger, sadness, or other emotions in the social media content to analyse sentiments. In one embodiment, the method includes using one or more machine learning models comprising Support Vector Machines (SVM), Random Forests, Regression Models, Neural Networks, Random Forest Regressor and Convolutional Neural Networks (CNNs). In a particular embodiment, analysing social media content may include filtering each social media content by tone based on identifying joy, anger, confidence and fear from the social media content and filtering each social media content by engagement based on engagement rate in the social media content comprising like, share and comment. In such an embodiment, analysing social media content may include provide weightage to like, share, comment, follow based on time taken for the engagement, wherein the weightage to the comments is based on number of words and tonality and intensity of tonality on the comments.

The method 300 further includes generating, by a button module, emoticon categorization and auto-suggestions based on metadata 360. The method 300 further includes predicting and suggesting, by the button module, relevant emoticons, mentions, and hashtags based on past user behavior, post content, and engagement patterns using machine learning algorithms 370. In one embodiment, generating emoticon categorization may include providing a plurality of emoticon under a like button to further categorize the likeness on the social media content as positive, negative or neutral response to define intensity of like, wherein the intensity of like is based on how long a specific button is pressed. In such an embodiment, generating emoticon categorization may include automatically suggesting mentions by a mention button based on meta data comprising surrounding, location, image analysis of the social media content, wherein the mentions are pre-populated based on the meta data using the one or more machine learning models, wherein the mentions are removed from the social media content when the user disapprove the social media content. In some embodiments, generating emoticon categorization may include automatically suggesting hashtags by a hashtag button based on meta data comprising surrounding, location, image analysis of the social media content, wherein the hashtags are pre-populated based on the meta data using the one or more machine learning models.

The method 300 further includes determining and ensuring, by a compliance module, compliance with laws applicable to varying jurisdictions and equivalent regulations of a corresponding governing body for compliance using one or more inputs upon identifying the transaction related data to adhere to regulations in paid social media content in step 380. In one embodiment, determining and ensuring compliance with laws automatically suggesting creation of the social media based on compliance by selecting (adding hashtag, image, code, URL, reference or disclosure) or correcting the post based on compliance or deny the post (or part of post) based on the compliance.

The method 300 further includes calculating, by a royalty distribution module, a plurality of royalties based on a predetermined percentage embedded in a smart contract on the blockchain platform for engagement, location, compliance, and fan type in step 390. The method 300 further includes distributing, by the royalty distribution module, the plurality of royalties based on the engagement, the location, the compliance, and the fan type using a distribution algorithm, thereby integrating functionalities to enhance user interaction, content analysis, and monetization opportunities in step 400.

In one embodiment, the method 300 may include offering or selling digital products or services in a marketplace interface for a user by a marketplace module. In some embodiments, the method 300 may include enabling, by a private group module, the user to establish and manage a private group for followers with membership. In such an embodiment, the method 300 may include permitting, by the private group module, the user to post content within the private group, wherein the content is exclusively accessible to followers with membership in the private group. In a particular embodiment, the method 300 may include enabling, by the private group module, followers to review or rate posted content within the private group using a review button, wherein the review button, when activated by a follower, facilitates the generation of credibility, reputation, and popularity metrics associated with the posted content based on the follower's review or rating. In another embodiment, the method 300 may include filtering, by the filtration module, paid and unpaid posts, wherein the paid posts of a specific user are aggregated and provided on a single feed. In such an embodiment, the method 300 may include ranking, by the filtration module, a common post on different social media platforms based on most engaged post of the specific user on any specific social media platform. In yet another embodiment, offering, by the social media account, social media account of other users for sale to the user.

Various embodiments of the present disclosure provide integrated social networking system described above enables the registration module to streamline the onboarding process, allowing influencers to link multiple social media accounts effortlessly. This results in a consolidated and easily accessible profile, saving time and providing a centralized hub for managing their online presence. The blockchain-powered bio page ensures secure storage of total audience reach and engagement metrics. This not only protects sensitive data but also provides influencers with a transparent and tamper-proof record of their performance across various social media platforms.

Furthermore, the payment gateway with a reward system facilitates seamless transactions and offers incentives based on audience reach and engagement metrics. This encourages influencers to create engaging content while efficiently monetizing their efforts. The CRM module provides personalized dashboards, offering insights into follower demographics and preferences. Administrative tools aid in managing relationships with fans, ensuring influencers can cultivate a dedicated and engaged audience.

Moreover, the analysis module, powered by natural language processing, offers a nuanced understanding of content tone, user interaction, and sentiment. This sophisticated analysis enables influencers to tailor their content strategy, enhancing engagement and resonance with their audience. The button module simplifies content interaction by suggesting emoticons, mentions, and hashtags based on past user behavior and engagement patterns. This not only saves time but also optimizes the visibility and impact of the influencer's posts.

In addition, the compliance analysis module ensures influencers remain in adherence to varying laws and regulations across jurisdictions. This feature is particularly beneficial for global influencers like Sarah, providing a trustworthy and compliant online presence. The royalty distribution module, supported by smart contracts on the blockchain, calculates and distributes royalties based on engagement, location, compliance, and fan type. This guarantees a fair and transparent system for influencers, optimizing their monetization opportunities while fostering trust within the platform.

In summary, the platform's integrated features empower users with efficient management tools, sophisticated analytics, and a compliant monetization system, ultimately enhancing their overall experience and impact in the competitive landscape of social media.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I claim:

1. A computer implemented integrated social networking system comprising:
a hardware processor; and
a memory coupled to the hardware processor, wherein the memory comprises a set of program instructions in the form of a processing subsystem, configured to be executed by the hardware processor, wherein the processing subsystem is hosted on a server and configured to execute on a network to control bidirectional communications among a plurality of modules comprising:
a registration module configured to perform user registration using one or more credentials to link a plurality of social media accounts;
a bio page module employing blockchain technology for data storage, wherein the bio page module configured to store total audience reach and engagement metrics obtained from a plurality of linked social media accounts;
a payment gateway module is configured to facilitate seamless transactions and incorporating a reward system based on the total audience reach and engagement metrics;
a customer relationship management (CRM) module configured to provide a plurality of dashboards for influencers, brands, agencies, and followers, with an administrative module for influencer-fan relationship management, third-party account access, and follower categorization;
an analysis module integrating natural language processing and configured to analyse social media content considering tone, engagement, and sentiment, wherein
the natural language processing identifies linguistic cues to determine positive, negative, or neutral tone in the social media content based on a plurality of factors comprising word choice, sentence structure, and context;
the natural language processing evaluates a way of user interaction with the social media content by tracking likes, shares, comments, and other metrics to analyse engagement;
the natural language processing analyses overall emotional tone of a piece of content by identifying joy, anger, sadness, or other emotions in the social media content to analyse sentiments;
a button module comprising like, mention, and hashtag buttons, configured to:
generate emoticon categorization and auto-suggestions based on metadata;
predict and suggest relevant emoticons, mentions, and hashtags based on past user behavior, post content, and engagement patterns using machine learning models;
a compliance analysis module configured to determine and ensure compliance with laws applicable to varying jurisdictions and equivalent regulations of a corresponding governing body for compliance using one or more inputs upon identifying the transaction related data to adhere to regulations in paid social media content; and
a royalty distribution module is configured to:
calculate a plurality of royalties based on a predetermined percentage embedded in a smart contract on the blockchain platform for engagement, location, compliance, and fan type; and
distribute the plurality of royalties based on the engagement, the location, the compliance, and the fan type using a distribution algorithm, thereby integrating functionalities to enhance user interaction, content analysis, and monetization opportunities.

2. The system of claim 1, wherein the bio page module is configured to display total audience reach, total number of likes, total number of mentions and total number of hashtags from a plurality of social media accounts.

3. The system of claim 1, wherein the processing subsystem comprises a marketplace module configured to offer or sell digital products or services in a marketplace interface for a user.

4. The system of claim 3, wherein the payment gateway module is configured to enable the user to shop, add to cart, pay and checkout, generate invoice and receipt of digital products or services in the marketplace interface.

5. The system of claim 1, wherein the payment gateway module is configured to allow the users to mention people or add hashtag in the social media content, wherein the people mentioned, or hash tagged in the social media content are rewarded points automatically by the social media platform.

6. The system of claim 1, wherein the customer relationship management module is configured to enable an influencer to create a database comprising details of fans such as type of a fan, how to connect and relationship of influencer with the fan.

7. The system of claim 1, wherein the customer relationship management module is configured to group all the followers into different categories comprising sports, movies, membership, engagement and geography suggested by the social media platform.

8. The system of claim 1, wherein the customer relationship management module is configured to manage sales performance management (SPM) for users (clients/influencers) along with other users (followers and brands along with their followers).

9. The system of claim 1, wherein the analysis module is configured to use one or more machine learning models comprising Support Vector Machines (SVM), Random Forests, Regression Models, Neural Networks, Random Forest Regressor and Convolutional Neural Networks (CNNs).

10. The system of claim 1, wherein the analysis module is configured to filter each social media content by
tone based on identifying joy, anger, confidence and fear from the social media content; and
engagement based on engagement rate in the social media content comprising like, share and comment.

11. The system of claim 1, wherein the analysis module is configured to provide weightage to like, share, comment, follow based on time taken for the engagement, wherein the weightage to the comments is based on number of words and tonality and intensity of tonality on the comments.

12. The system of claim 1, wherein the like button of the button module is configured to provide a plurality of emoticon under the like button to further categorize the likeness on the social media content as positive, negative or neutral response to define intensity of like, wherein the intensity of like is based on how long a specific button is pressed.

13. The system of claim 1, wherein the mention button of the button module is configured to automatically suggest mentions based on meta data comprising surrounding, location, image analysis of the social media content, wherein the mentions are pre-populated based on the meta data using the one or more machine learning models, wherein the mentions are removed from the social media content when the user disapprove the social media content.

14. The system of claim 1, wherein the hashtag button of the button module is configured to automatically suggest hashtags based on meta data comprising surrounding, location, image analysis of the social media content, wherein the hashtags are pre-populated based on the meta data using the one or more machine learning models.

15. The system of claim 1, wherein the compliance module is configured to automatically suggest creation of the social media based on compliance by selecting (adding hashtag, image, code, URL, reference or disclosure) or correcting the post based on compliance or deny the post (or part of post) based on the compliance.

16. The system of claim 1, the processing subsystem comprises a private group creation module configured to:
enable the user to establish and manage a private group for followers with membership;
permit the user to post content within the private group, wherein the content is exclusively accessible to followers with membership in the private group; and
enable followers to review or rate posted content within the private group using a review button, wherein the review button, when activated by a follower, facilitates the generation of credibility, reputation, and popularity metrics associated with the posted content based on the follower's review or rating.

17. The system of claim 1, wherein the processing subsystem comprises a filtration module configured to filter paid and unpaid posts, wherein the paid posts of a specific user is aggregated and provided on a single feed.

18. The system of claim 17, wherein the filtration module is configured to rank a common post on different social media platforms based on most engaged post of the specific user on any specific social media platform.

19. The system of claim 1, wherein the processing subsystem comprises a social media account selling module configured to offer social media account of other users for sale to the user.

20. A method comprising:
performing, by a registration module, user registration using one or more credentials to link a plurality of social media accounts;
storing, by a bio page module, total audience reach, and engagement metrics obtained from a plurality of linked social media accounts, wherein the bio page is employed with blockchain technology for data storage;
facilitating, by a payment gateway module, seamless transactions and incorporating a reward system based on the total audience reach and engagement metrics;
providing, by a customer relationship management (CRM) module, a plurality of dashboards for influencers, brands, agencies, and followers, with an administrative module for influencer-fan relationship management, third-party account access, and follower categorization;
analysing, by a analysis module, social media content considering tone, engagement, and sentiment, wherein the natural language processing identifies linguistic cues to determine positive, negative, or neutral tone in the social media content based on a plurality of factors comprising word choice, sentence structure, and context, wherein the natural language processing evaluates a way of user interaction with the social media content by tracking likes, shares, comments, and other metrics to analyse engagement, wherein the natural language processing analyses overall emotional tone of a piece of content by identifying joy, anger, sadness, or other emotions in the social media content to analyse sentiments;
generating, by a button module, emoticon categorization and auto-suggestions based on metadata;
predicting and suggesting, by the button module, relevant emoticons, mentions, and hashtags based on past user behavior, post content, and engagement patterns using machine learning algorithms;
determining and ensuring, by a compliance module, compliance with laws applicable to varying jurisdictions and equivalent regulations of a corresponding governing body for compliance using one or more inputs upon identifying the transaction related data to adhere to regulations in paid social media content;
calculating, by a royalty distribution module, a plurality of royalties based on a predetermined percentage embedded in a smart contract on the blockchain platform for engagement, location, compliance, and fan type; and
distributing, by the royalty distribution module, the plurality of royalties based on the engagement, the location, the compliance, and the fan type using a distribution algorithm, thereby integrating functionalities to enhance user interaction, content analysis, and monetization opportunities.
